(19) United States
(12) Patent Application Publication
(10) Pub. No.: US 2009/0164499 A1
(43) Pub. Date: Jun. 25, 2009

(54) CREATING POLICY RULES AND ASSOCIATED POLICY RULE COMPONENTS

(75) Inventors: Srinivasa C. Samudrala, Irving, TX (US); Gregory W. Cox, Schaumburg, IL (US); John C. Strassner, North Barrington, IL (US)

Correspondence Address: FLEIT, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/961,306

(22) Filed: Dec. 20, 2007

(51) Int. Cl. G06F 7/00; H04L 9/00

(52) U.S. Cl. 707/102; 726/1; 707/E17.005; 707/E17.143

(57) ABSTRACT

A method and information processing system manage policy elements in an information processing system. At least one policy element (110) from a plurality of policy elements stored in at least one policy repository (108) is retrieved. The plurality of policy elements includes at least one of a plurality of reusable policy rules (110), a plurality of reusable policy rule components (118, 120, 122), a plurality of reusable policy rule templates, and a plurality of and policy rule component templates. A new reusable policy element is created from at least one of the policy element (110) that has been retrieved and a default policy element. The new reusable policy element is stored in the at least one policy repository (108). A reusable policy element is queried using metadata (224) associated with the reusable policy element.

### FIELD OF THE INVENTION

The present invention generally relates to the field of policy management and network management, and more particularly relates to a policy management system for managing policy rules and reusable components of policy rules.

### BACKGROUND OF THE INVENTION

Managing policy rules is inherently complex because policy rules are used to control almost all aspects of the functionality of components, devices, and systems that are governed by policy. Recent trends for managing next generation networks, including self-governing autonomic networks, as well as more diverse and complete approaches (e.g., using the Policy Continuum, as described in the co-pending application Ser. No. 11/617,369 entitled “Creating and Managing A Policy Continuum” filed on Dec. 28, 2006, which is commonly assigned to Motorola, Inc. and hereby incorporated by reference in its entirety), increase the need for managing policy rules.

Building a set of policy rules for managing an entire network is complicated by many factors such as requiring collaborative effort from a group of experts. This complication is further increased by the following factors as well: different vendors using different programming languages and management data (i.e., policy rules generally must be able to be translated to each vendor's language and management data); lack of a common data model, which would (1) allow a common representation of policy to be established, (2) allow a common representation of device functionality that is to be controlled to be established, and (3) allow common policy rules to govern heterogeneous functionality of different devices Therefore, to manage different functionality, different people having specific skills are required to work together to define collaborative policies. Current Role Based Access Control (RBAC) Systems do not provide an environment that allows a group of experts who have knowledge of various aspects of the system to collaboratively build a policy rule comprising component Policy Events, Policy Conditions, Policy Actions and Metadata, since said RBAC systems are used only for access control, and not as a means to enable different policy authors to work together.

Therefore a need exists to overcome the problems with the prior art as discussed above.

### SUMMARY OF THE INVENTION

In one embodiment, a method for managing policy elements in an information processing system is disclosed. The method includes retrieving at least one policy element from a plurality of policy elements stored in at least one policy repository. The plurality of policy elements includes at least one of a plurality of reusable policy rules, a plurality of reusable policy rule components, a plurality of reusable policy rule templates, and a plurality of and policy rule component templates. A new reusable policy element is created from at least one of the policy element that has been retrieved and a default policy element. The new reusable policy element is stored in the at least one policy repository. A reusable policy element is queried using metadata associated with the reusable policy element.

In another embodiment, another method for managing policy elements in an information processing system is disclosed. The method includes retrieving at least one policy element from a plurality of policy elements stored in at least one policy repository. The plurality of policy elements includes at least one of a plurality of reusable policy rules, a plurality of reusable policy rule components, a plurality of reusable policy rule templates, and a plurality of and policy rule component templates. A new reusable policy element is created from at least one of the policy element that has been retrieved and a default policy element. The new reusable policy element is stored in the at least one policy repository. A reusable policy element is queried using metadata associated with the reusable policy element. A set of permissions that are associated with at least one of a human user and a machine user are determined. One of the human user and the machine user are authorized to perform a set of management operations on the new reusable policy element based on the set of permissions determined to be associated with the at least one human user and the machine user.

In yet another embodiment, an information processing system for managing policy elements in an information processing system is disclosed. The information processing system includes a memory and a processor that is communicatively coupled to the memory. The information processing system also includes a policy manager that is communicatively coupled to the memory and the processor. The policy manager is adapted to retrieve at least one policy element from a plurality of policy elements stored in at least one policy repository is retrieved. The plurality of policy elements includes at least one of a plurality of reusable policy rules, a plurality of reusable policy rule components, a plurality of reusable policy rule templates, and a plurality of and policy rule component templates. A new reusable policy element is created from at least one of the policy element that has been retrieved and a default policy element. The new reusable policy element is stored in the at least one policy repository. A reusable policy element is queried using metadata associated with the reusable policy element.

An advantage of the foregoing embodiments of the present invention is that policy rules and their associated components (i.e. Policy Events, Policy Conditions, Policy Actions, and Metadata) can be efficiently managed. Note that in the foregoing embodiment, a policy rule component is defined as an object or set of objects that are part of a policy rule. Note further that prior art, in general, uses the term “policy component” in a completely different way than the forgoing embodiments. For example, prior art generally uses the term “policy component” as a means to perform actions on or services associated with policy or a policy rule. Finally, the various embodiments of the present invention use Metadata in a novel way: metadata can be applied to a Policy Rule as well as to any or all of its components (the Policy Rule Components). This use of Metadata provides unparalleled flexibility in the definition, organization, and resulting behavior of Policy Rules and Policy Rule Components.

One example of the prior art usage of “policy component” is given in U.S. Pat. No. 6,834,301, which is hereby incorporated by reference in its entirety. This patent defines several “policy components” that operate on policy in different ways such as the “get policy component” and the “calculate policy component”. Also, the repository here is for network data, not policy rules. This patent does not teach the reuse of policy components. U.S. Pat. No. 7,103,351, which is hereby incorporated by reference in its entirety, gives another example of prior art use of policy components. Here again, the policy component operates on policy rules rather than being a part of policy rules. A policy in this prior art example does not include events. These prior examples represent a fundamental difference between the foregoing embodiments and the prior art. The forgoing embodiments define reusable, managed policy rule components for use in constructing and evaluating policy rules.

Since the Events (that trigger the policy), the Conditions (that determine if actions are to be taken), and the Actions are specified as different components of the policy, it is usually easier to build and manage the policy as discrete components, rather than treating each policy rule as an indivisible whole. This gives the user better control over the content of the policy rule, since the policy rule is, in reality, an intelligent container (See for example page 64 of Strassner, John C.: “Policy Based Network Management”, San Francisco: Morgan Kaufmann Publishers, 2004, which is hereby incorporated by reference in its entirety).

Accordingly, the various embodiments of the present invention treat policy rules and policy rule components as separate entities in the system, and therefore, facilitates applying Role Based Access Control (“RBAC”) to both policy rules as well as policy rule components. The various embodiments of the present invention also enable MetaRules (i.e., rules about rules and rule components) to track and enforce RBAC-based constraints on these policy rules and policy rule components.

The various embodiments of the present invention can also be used to create a repository of Policy Rules, Events, Conditions, Actions, and Metadata. It should be noted that the terms “library” and “repository” can be used interchangeably throughout this discussion. In one embodiment, the term “library” denotes an organized collection of policy rules and policy rule components. The term “library” referred to throughout this discussion, in one embodiment, is a virtual organization, i.e., a physical storage mechanism is not prescribed. Rather, the library can span one or more physical repositories, and uses the Metadata attached to policy rules and policy rule components, as defined by the various embodiments of the present invention, to organize storage, retrieval, querying, updating, and other management functions. A physical repository occupies a single physical location; a virtual repository is a collection of physical repositories that logically appear as a single repository (i.e., an entry can be addressed independent of knowing its location), even though they occupy different physical locations. The various embodiments of the present invention describe how a set of reusable libraries (that can include policy rules, policy elements, and templates for both) can be stored, queried and accessed from a single or multiple, physical or virtual repositories.

The library, in one embodiment, enables users to build reusable components (which can be Events, Conditions, Actions, and Metadata) that can be used in different policies without needing to create new Events, Conditions, Actions, and Metadata separately for each policy. This reusability makes it easier for the network operator to build new policies using the same set of components from one or more libraries since the network operator already understands the behavior of an existing policy rule component. In addition, this reusability drastically reduces the time needed to build a new policy or make changes to older ones while enhancing the reliability and maintainability of the resulting Policy Rules. Note that since reusable library elements can also have attached RBAC permissions and MetaRules, access control and security are also reused.

Another advantage of the foregoing embodiments of the present invention is that the Event, Condition, Action paradigm also facilitates abstraction. This is useful in a scenario where a network technician, who understands alarms in a network and has expertise in using them to build meaningful Events, is allowed to use only the Event part of the policy management application such as (but not limited to) a GUI and/or a script interface. The network technician need not understand the complete policy, and is only concerned with building and managing Events. It is up to the network operator or a system administrator to use these Events to trigger the evaluation of appropriate policies.

Furthermore, the network operator or system administrator need not understand the nuances of the Events, what alarms comprise the Events, how to build Events, etc. He or she only needs to have a high level understanding of why the Events are being generated and what policies should be triggered to handle these Events. The various embodiments of the present invention, therefore, provide an appropriate abstraction to be created between the policy rule and its components. This abstraction enables the user to see only the part of the policy that concerns a particular group of users (e.g., as identified by users having a given role) and reduces the confusion and chances of an error occurring by preventing a user from accidentally changing a policy rule or component that is not in his or her area of expertise. This abstraction also avoids complicating the user's task by presenting the user needless information (e.g., only the portion of the policy rule or component that the user can manage is represented), which helps build efficiency in the user's operation of his or her task.

Yet another advantage of the foregoing embodiments is levels of access can be defined to ensure that different user groups have access to operate only on the part of the policy that is relevant to them. Also, by allowing the users to create new Events, Conditions and Actions on the fly (by using either the default templates or by changing pre-built library components), and moving them to their appropriate libraries, the foregoing embodiments ensure that the policies are extensible.

Finally, the foregoing embodiments allow policies to store references to other policies in a Policy Continuum and navigate thorough the hierarchy. This allows the user to see exactly how the policies are being mapped as they navigate through the Policy Continuum, provided they have the required permissions.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a policy management system, according to one embodiment of the present invention;

FIG. 2 illustrates a detailed view of a Policy Rule, according to one embodiment of the present invention;

FIG. 3 shows an example of two different applications of RBAC to the structuring of Policy Rules and their components according to one embodiment of the present invention;

FIG. 4 is a block diagram illustrating MetaRule Constraints, according to one embodiment of the present invention;

FIG. 5 is an operational flow diagram illustrating a process of creating Contained Policy Rule Components in a Policy Rule or a Policy Rule Template;

FIG. 6 is an operational flow diagram illustrating a process of creating a Policy Rule or a Policy Rule Template, according to one embodiment of the present invention; and

FIG. 7 is a block diagram illustrating a detailed view of an information processing system, according to one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term “wireless device” is intended to broadly cover many different types of devices that can wirelessly receive signals, and optionally can wirelessly transmit signals, and may also operate in a wireless communication system. For example, and not for any limitation, a wireless communication device can include any one or a combination of the following: a two-way radio, a cellular telephone, a mobile phone, a smartphone, a two-way pager, a wireless messaging device, a laptop/computer, automotive gateway, residential gateway, and the like.

Also, the term “Policy Events” may be equivalently referred to as “Events”. The term “Policy Conditions” may be equivalently referred to as “Conditions”. The term “Policy Actions” may be equivalently referred to as “Actions”. The term “Policy Rules” may be equivalently referred to as “Rules”. Also, as discussed above, the terms “library” and “repository” can be used interchangeably throughout this discussion.

Policy Management System

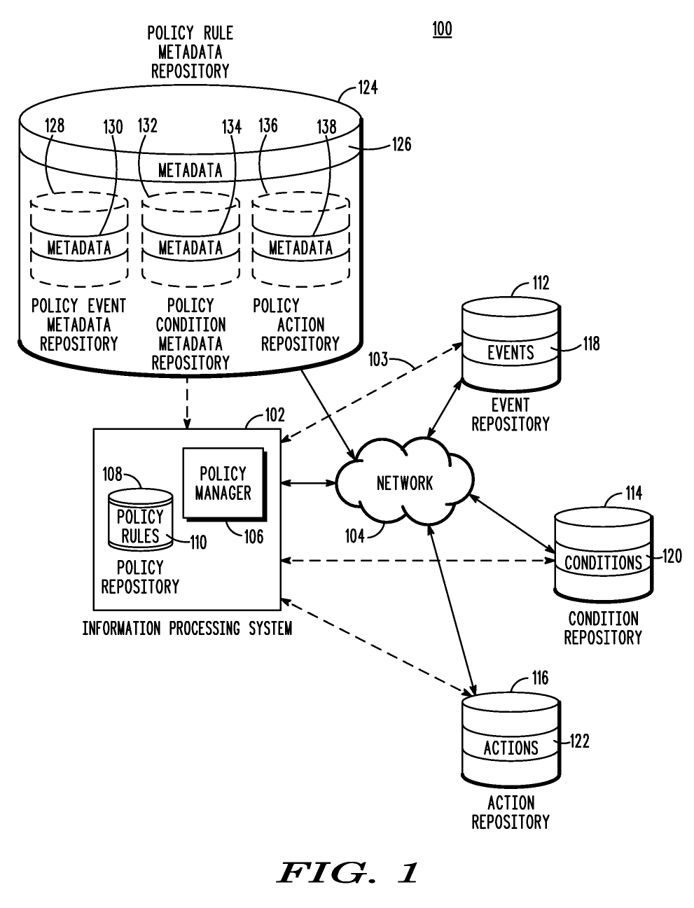

According to an embodiment of the present invention as shown in FIG. 1 a policy management system 100 is illustrated. It should be noted that FIG. 1 illustrates only one configuration of the policy management system 100. For example, one or more of the components in the policy management system 100 can reside on a single system and are not coupled to one another via a network 104. Stated differently, the policy management system 100 is independent of repository type and location.

FIG. 1 shows one or more information processing systems 102 that are communicatively coupled to the policy management system 100, either locally (in the same system using a messaging service 103) and/or externally via at least one network 104 such as a Local Area Network (“LAN”), Wide Area Network (“WAN”), or another network configuration. The network 104 can be a wired network or a wireless network. The information processing system 102 can be a workstation, server, desktop computer, notebook, or other type of system.

The information processing system 102, in one embodiment, includes a policy manager 106. The policy manager 106 manages policy rules and their associated components. The policy rule/policy rule component management process is discussed in greater detail below. The information processing system 102, in one embodiment, includes a policy repository 108 for storing policy rules 110. As discussed above, a library is a virtual organizational structure that resides within a repository. It should be noted that the policy repository 108 is not limited to residing within the information processing system 102. For example, the policy repository 108 can reside outside the information processing system 102 and be coupled through the network 104 or messaging bus 103. Likewise, the policy manager 106 is not limited to residing within the information processing system 102. For example, the policy manager 106 can reside outside the information processing system 102 and be coupled through the network 104 or messaging bus 103.

The policy manager 106 is also communicatively coupled to an event repository 112, a condition repository 114, an action repository 116, and a metadata repository 124. The use of these four repositories provides maximal reuse while keeping their management processes separate. However, one or more embodiments of the present invention also include a simpler case where a fewer number of repositories are used to store policy rules and their policy rule components. In the example of FIG. 1 each of these repositories 112, 114, 116, 124 are communicatively coupled to the policy manager 106 via the messaging bus 103, but can also be communicatively coupled to the network 104. It should be noted that one or more of these repositories 112, 114, 116, 124 can also reside within the information processing system 102.

The event repository 112 comprises Events 118; the condition repository 114 comprises Conditions 120; the action repository 116 comprises Actions 122; and the Metadata repository 124 comprises Metadata 126. Also, policy rules, policy rule components, policy rule templates, and policy rule component templates can be stored across different repositories than one another. These repositories can be of a different physical entity or a different logical partition of an original physical entity. This enables both physical and logical security to be exercised on as a granular basis as possible. Policy rules, policy rule components, policy rule templates, and policy rule component templates can be collectively referred to policy elements.

Optionally, the policy rule Metadata repository 124 and policy rule Metadata contents 126 can be supplemented by having a policy event Metadata repository 128 and contents 130, a policy condition Metadata repository 132 and contents 134, and a policy action Metadata repository 136 and contents 138. Each of these repositories 112, 114, 116, 124, 128, 132, 136 and their respective contents 118, 120, 122, 126, 130, 134, 138 are discussed in greater detail below. Note, however, that just as with policy rule Metadata 126, the policy rule component Metadata 130, 134, 138 do not have to be present, nor do they have to be located in separate repositories (i.e., they could share the policy rule repository 124).

Policy Rules and their Components

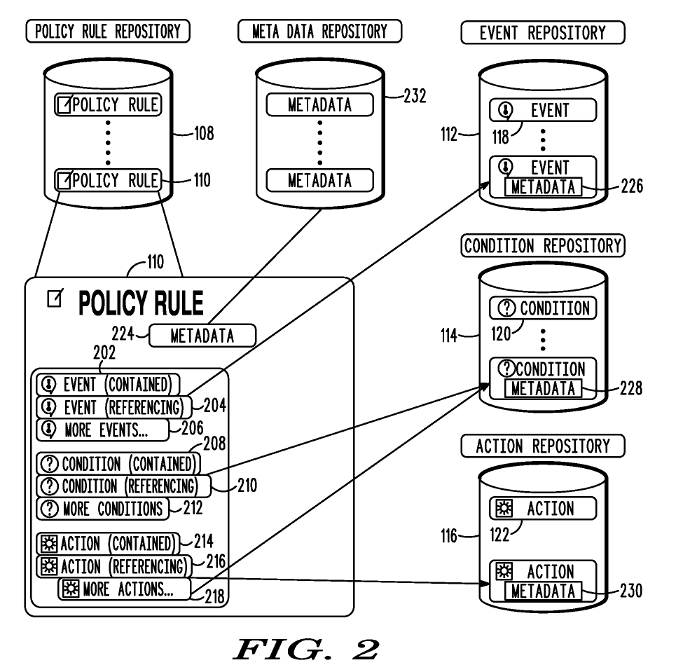

As discussed above, one embodiment of the present invention comprises a policy management system 100 for managing policy rules 110 and the policy rule components 202-218 and 224 (Events, Conditions, Actions, and Metadata) (FIG. 2) of policy rules 110. Managing policy rules 110 can include creating, editing, organizing, deleting, querying, executing, and representing policy rules 110, its Metadata 224, and its policy rule components 202-218 and their Metadata 226-230. Since a policy rule 110 is made up of a set of policy rule components 202-218 and their Metadata 226-230, the above definition can be extended to reusing policy rule components 202-218 with their Metadata 226-230 and policy rules 110 with their Metadata 224; to construct more complex policy rule components 202-218 and their Metadata 226-230 and policy rules 110 and its Metadata 224. For example, a complex policy rule component can be constructed out of a set of simpler policy rule components (e.g., a complex policy condition comprising multiple simple conditions) and a policy rule 110 can be created from a set of policy rule components 118, 120, 122, 126.

Metadata 224, in one embodiment, is used to describe the behavior and characteristics of a policy rule. In addition, each policy rule component, in one embodiment, includes its own Metadata 226, 228, 230 to describe the behavior and characteristics of the particular Policy Events, Policy Conditions and Policy Actions that a given policy rule uses. Note that each metadata 224, 226, 228, 230 behaves as a reusable component (that can be stored in a separate repository/), and can be used across multiple policy rules similar to the reusability of a policy rule component 118, 120, and 122.

Conceptually, a policy rule 110 can be thought of as an intelligent data container that serves to aggregate one or more policy Events 118, one or more policy Conditions 120, and one or more policy Actions 122. For example, Events 118, Conditions 120, and Actions 122 can be composed independent of each other and hence, should not store references to each other. Therefore, the policy rule 110 acts as a container for collecting Events 202, 204, 206, Conditions 208, 210, 212 and Actions 214, 216, 218 and provides these references automatically. Throughout this discussion, Policy Events 118, Policy Conditions 120, and Policy Actions 122 are referred to as Policy Rule Components. In addition, a policy rule 110 itself has additional data and metadata 224 that enable generic and/or rule-specific behavior to be associated with a policy rule 110, just as each of the policy rule components 118, 120,122 has metadata 226, 228, 230, respectively. For example, the metadata 224 can indicate the appropriate context in which the policy rule should be applied.

Events 202, 204, 206 are used to decide when to trigger the evaluation of the Condition(s) 208, 210, 212 of the policy. The Conditions 208, 210, 212, in one embodiment, are used to test the state of the system being monitored and determine which action(s), if any, are to be taken. The Actions 214, 216, 218, in one embodiment, define any operations to be performed to either maintain the current state or transition the system to a new desired state. Actions can optionally be specified for both the occasion when the result of the condition clause is TRUE (pass actions) and when the result of the condition clause is FALSE (fail actions). The policy manager 106 allows a policy author to organize these policy rule components (Events, Conditions and Actions) directly into separate repositories 112, 114, 116 and optionally, to construct libraries of policy rule components. As discussed above, the Policy Rule 110 has its own dedicated Metadata 224, while the Events, Conditions, and Actions each have their own dedicated Metadata 226, 228, 230. The policy rule Metadata 224 and policy rule component Metadata 226, 228, 230 can be stored in any combination of a single repository or up to four repositories, as explained above.

FIG. 2 illustrates a more detailed view of a policy rule 110. As shown in FIG. 2, a policy rule 110 comprises metadata 224 that describes the behavior and characteristics of the policy rule 110, enables generic and/or rule-specific behavior to be associated with the policy rule 110, and indicates how policy rule Components are used with the policy rule 110. FIG. 2 also shows that the policy rule 110 includes one or more Policy Events 118, Policy Conditions 120, and Policy Actions 122 (these three objects are collectively called Policy Rule Components). These Policy Rule Components 118, 120, 122 can either be Contained components (i.e., fully defined in the policy rule 110 itself and used exclusively therein) or Referencing components (i.e., components that reference other components, where the components that are Referenced are called Referenced components and can be used in multiple policy rules). Referenced Components may reside in a Policy Rule, a Policy Rule template (in which case the Referenced Component is a Contained component with respect to the Policy Rule or Policy Rule template it resides in, but is a Referenced Component with respect to the Referencing Component that refers to it) or independently in a separate repository.

For example, FIG. 2 shows the policy rule 110 including a Contained event(s) 202, a Referencing event(s) 204, and additional events 206. The policy rule 110 also includes a Contained condition(s) 208, a Referencing condition(s) 210, and additional conditions 212. FIG. 2 also shows the policy rule 110 including a Contained action(s) 214, a Referencing action(s) 216, and additional actions 218. Each of the Contained components 202, 208, 214 is fully defined within the policy rule 110, whereas each of the Referencing components 204, 210, 216 is referencing other components outside of the policy rule 110. The components referenced by these Referencing components 204, 210, 216, in one embodiment, are each stored in their respective repository(s) 112, 114, 116.

However, it is not necessary that a Referenced component be stored in a physically separate or even a logically separate repository. In some cases a Referencing component might reference another component stored in the same policy rule 110. Thus, there are three types of components used the various embodiments of the present invention: (1) a Contained component, which is completely defined in the policy rule 110 that includes it; (2) a Referenced component that is stored in a repository (as opposed to embedded within the policy rule like Contained components); and (3) a Referencing Component, which is also included in the policy rule that includes it, but which references either a Contained or a Referenced component.

In various embodiments of the present invention, Referencing components are stored in the component or rule that defines them. In some embodiments of this invention, Referenced components also store “back-pointers” to their referencing components. The use of such “back-pointers” is an application-specific design decision, and involves tradeoffs between storage and efficiency. This facilitates management and maintenance of policy rules and policy rule components. For example, if a particular condition needs to be changed, then in one embodiment, all that is needed is to edit that particular condition once. All users of that condition (e.g., all the policy rules that use that condition) are automatically updated, since they include references to the (edited) condition, not the actual condition itself.

The reason for storing links in both directions is to enable a Referenced component that is updated or deleted to broadcast this change to all the Referencing components using it. This allows the Referencing components to be changed near real time with no action from the user. In another embodiment, a Referenced component can simply broadcast a message indicating that it has been changed (instead of broadcasting the change itself). This notification causes the Referencing component, for example, to indicate to the user that a change has occurred and that the user needs to refresh his/her view of the component.

Thus, a policy rule 110, which comprises metadata 224, 226, 228, 230, Policy Events 202, 204, 206, Policy Conditions 210, 212, 214, and Policy Actions 214, 216, 218 as discussed above, can be built collaboratively by a group of experts who have knowledge of various aspects of the system. Note that policy rules are not inherently restricted in size or complexity. Indeed, large systems with complex goals may typically require very complex policy rules. This complexity engenders the need for team authorship of policy rules. One embodiment of the present invention, addresses this need by enabling different users to work on all or part of a policy rule 110. For example, one set of users can focus on the alarms and events that are relevant to monitor the system or its components.

Similarly, another set of users can focus on the conditions that are to be checked for correctly deducing the state of the system being monitored, while a third set of users can focus on the actions to be taken to either maintain the current state or transition the system to a new desired state. In an alternate example, one set of users can focus on the events, conditions and actions associated with a particular type of managed entity (e.g., a particular type of router made by one set of vendors) while another set of users can focus on the events, conditions, and actions associated with another type of managed entity (e.g., a switch made by a different set of vendors). The various embodiments of the present invention also facilitate coordination between these users who are experts in specific equipment types rather than policy rule component types as in the prior example.

It should be noted that in FIG. 2 the Events 118, Conditions 120, Actions 122, and policy rules 110 are shown in their respective libraries and also as part of the policy rule(s) they belong to only for illustrative purposes. Exploring a policy rule 110 shows the Events 202, 204, 206, Conditions 208, 210, 212, Actions 214, 216, 218, and the Metadata for each (224, 226, 228, 230 respectively) that make up that policy rule 110, assuming that the user has appropriate access to see its components. Other, more privileged, users are able to perform other actions according to the capabilities defined by their roles to the policy rule and their components. The details of these Events 202, 204, 206, Conditions 208, 210, 212, and Actions 214, 216, 218 and the Metadata for each (226, 228, 230 respectively) may be shown to the user depending on the user's privileges. These additional details include viewing and possibly editing the definition of each component, associated metadata, and any sub-Events, sub-Conditions and sub-Actions that are contained by the corresponding Event, Condition, or Action, respectively, as well as creating Referenced and/or Contained components, and performing operations on the Referenced and Contained components as previously discussed.

The paradigm used for representing components of a policy rule 110 also applies to the sub-components of Events 202, 204, 206, Conditions 208, 210, 212, and Actions 214, 216, 218. This paradigm allows simple and/or composite policy rules, Events, Conditions, and Actions as discussed in the DEN-ng information model to be constructed. The DEN-ng information model employs UML to describe the entities involved in policy (e.g., Events, Conditions, and Actions) as object-oriented classes using associations and association classes to describe the relationships between policy entities. This provides an extensible structure for policy management that can be used in conjunction with various embodiments of the present invention. The DEN-ng information model is discussed in greater detail in Strassner, John C.: “Policy Based Network Management”, San Francisco: Morgan Kaufmann Publishers, 2004.

Since the Events 202, 204, 206, Conditions 208, 210, 212, Actions 214, 216, 218, and Metadata 224 also store cross-references to the policy rules 110 that they are contained in, these Events 202, 204, 206, Conditions 208, 210, 212, and Actions 214, 216, 218 can also be explored to find all the policy rules that contain them. Similarly, the Event, Condition, and Action Metadata 226, 228, 230 store cross-references to their Events 202-206, Conditions 208-212, and Actions 214-218. This allows the user to examine the hierarchy in both a top-down as well as a bottom-up fashion. For example, in one embodiment, the user can browse a policy rule 110 and navigate down the hierarchy to see the details of its components (Events, Conditions, Actions, and Metadata) of the policy rule 110 (including symbology to differentiate whether a component is Contained or Referenced). The user can also navigate up the hierarchy of a policy rule component (for example an Action) and find all the policy rules 110 that use that particular component (in this case, the user can find out all the policy rules 110 that use this particular Action). This allows the user to make changes to a particular component knowing which policy rules are to be impacted by those changes.

Besides this complexity involved in building policy rules 110, a Policy Continuum specifies various levels for a policy rule 110. Lower-level policies tend to include more specific detail in a narrower scope (e.g., they are usually confined to govern functionality of a specific device), while higher-level policies (e.g., “John gets Gold Service”) by definition require significant subsequent effort to translate them to a form suitable for consumption by the target(s) of the policy rule 110.

A critical component of managing policy rules 110, in one embodiment, is governing access privileges to each policy rule. Since policy controls functionality, access should be in general carefully controlled. This includes 1) use of a mechanism such as RBAC to ensure that only the relevant subset of policy rules are exposed to the people using and/or managing the policy; 2) providing different access levels to a person or group of people based on their roles; and 3) enabling different parts of the policy rule (i.e., policy rule components) to be managed by different roles (e.g., enabling one set of people to develop (reusable) policy events, conditions and actions, and another set of people to develop policy rules that use these reusable policy rule components).

For example, referring back to FIG. 2, this figure shows that different repositories 118, 120, 122 can be used to build a policy rule 110. Therefore, one embodiment of the present invention enables the components 202-218 of the policy rule (as well as the policy rule 110 itself) to each impose their own access control restrictions. This can be performed by associating different Role Based Access Control rules to each of the different repositories 110, 112, 114, 116, 124, 128, 132, 136 that include the policy rule 110 and/or components 202-218 of the policy rule 110, as well as the policy rule metadata 224 and/or the policy rule component metadata 226, 228, 230. FIG. 2 shows this application of RBAC according to one embodiment of the present invention.

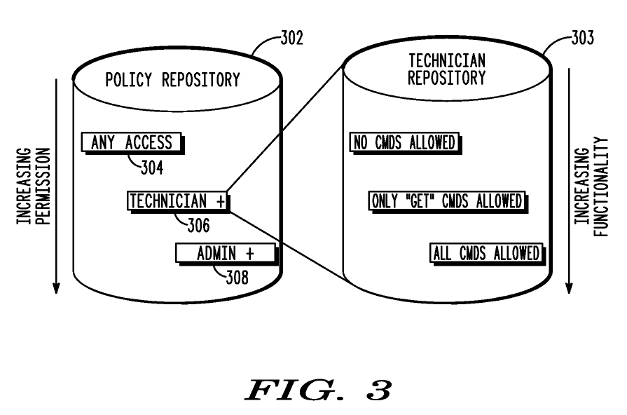

FIG. 3 shows an example of two different applications of RBAC with respect to the structuring of policy rules and their components according to an embodiment of the present invention. The Policy Repository 302 on the left uses a hierarchy to define individual and role access control permissions. With respect to the Policy Repository 302, decreasing levels in the repository 302 represent the RBAC hierarchy, which further restricts access. For example, Policies placed in the “Any Access” partition 304 of the Policy Repository 302 can be accessed by anyone, whereas Policies placed in the “Technician+” portion 306 needs at least a “Technician” role to be accessed. Similarly, Policies placed in the “Admin+” role 308 need at least an “Admin” role to be accessed, where “Admin” has more permissions than “Technician” (i.e., the role “Admin+” is a subclass of the role “Technician+”).

Note that in the above example, a “partition” is a specific region of a repository set aside for a particular purpose. The various embodiments of the present invention can also achieve a similar function by associating storage locations and/or components with tags (e.g., metadata) that provide the same functionality. Furthermore, this discussion assumes than an embodiment uses the role-object pattern. This pattern is used to adapt the same object to different client needs transparently by attaching one or more role objects to the original object. Each context is kept separate by the different role objects. This role-object pattern is further discussed at (www.cs.uiuc.edu/users/hanmer/PLoP-97/Proceedings/riehle.pdf), which is hereby incorporated by reference in its entirety. The DEN-ng information model uses this pattern throughout its design. Thus, this approach uses a hierarchy to provide increasing role access control levels. By placing policy rules 110 and their components 202-218 into appropriate levels in a hierarchy, the policy rule 108 and its constituent components 202-218 are protected.

FIG. 3 also shows an approach in which a hierarchy is used to provide increasing functionality. The technician repository 303 shows decreased levels in the repository 303 that represent the application of RBAC permissions, which add stability to perform more functionality. This is similar to the first approach, but uses role functionality (e.g., the “power” or “complexity” or “knowledge required” of the command) in the same way that the first approach used role authority (e.g., how “privileged” was the user). These two approaches are examples; other approaches can be defined as well. By enabling a policy rule 110 and its constituent components 202-218 to be placed in different storage areas that are themselves governed by RBAC rules (or alternatively, embedding tags in the storage locations and/or objects to provide this functionality), the policy rule 110 and its components 202-218 respect the restrictions defined by RBAC. Current Policy management systems do not provide this functionality. In addition, one embodiment of the present invention provides an innovative mechanism for enabling metadata 224-230 to be used to ensure the integrity of the placement of policy rules 110 and their components 202-218.

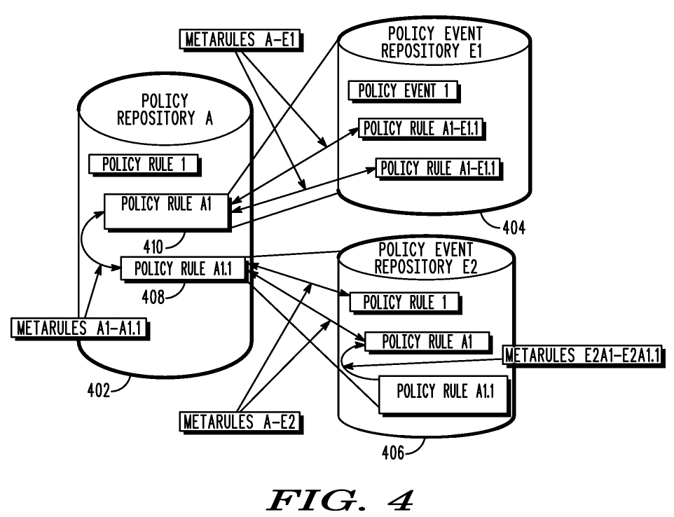

FIG. 4 shows this application of metadata according to one embodiment of the present invention. FIG. 4 illustrates the concept of “MetaRule Constraints”. In this approach, constraints are defined that realize the RBAC concepts being enforced. FIG. 4 shows a Policy Repository A 402, a Policy Event Repository E1 404, and a Policy Event Repository E2 406. Each of the Policy Event Repository E1 404 and the Policy Event Repository E2 406 are communicatively coupled to the Policy Repository A 402. A policy rule A1.1 408 is a sub-rule of policy rule A1 410 (meaning that policy rule A1 410 is not completely evaluated and executed until policy rule A1.1 408 has been evaluated and executed).

Hence, there is a constraint between policy rule A1 410 and policy rule A1.1 408. Now, if policy rule A1 410 is placed at a certain level in the RBAC hierarchy, a MetaRule (which is a policy rule governing a policy rule) can be defined for ensuring that the access control defined for policy rule A1.1 408 is at least at the level of the access control for policy rule A1 410. (Note that this does not need to occur all the time; however, there exists situations in which it is beneficial to protect the integrity of the “inner rules” (or components) from those of the “outer rules” (or components). One embodiment of the present invention comprises this capability.

Consider the task of using policy rules to control the construction of a router configuration. Portions of the router configuration are the same regardless of where the router is located or how it is used (e.g., defining and using the same access control list). However, other portions are specific to how the router is used (e.g., traffic engineering or peering with specific autonomous systems). Suppose the organization using policy rules want to also use RBAC to ensure that only qualified personnel edit certain portions of the router configuration (e.g., the traffic engineering portion). One embodiment of the present invention enables this capability as follows. The policy manager 106 constructs a set of repositories according to the desired personnel roles. The policy manager 106, places policy rules 110 and their constituent components 202-218 in appropriate repository positions (i.e., partitions) or embeds metadata in the storage locations and/or policy objects to ensure proper access control. The policy manager 106 defines metadata 224-230 that ensure that each policy rule 110 and policy rule component 202-218 are constrained according to their function (e.g., a rule originally placed in a restricted storage area generally cannot be placed in a less restricted storage area unless an administrator with appropriate permissions does so; one such method is to create a new rule from the existing rule and change its permissions).

The following is a more detailed discussion of Contained policy rule components and Referenced policy rule components. To get better performance out of the policy management system 100, a policy rule 110 can also directly contain Event 202, 204, 206, Condition 208, 210, 212, and Action 214, 216, 218 components instead of referencing them. Referring back to FIG. 2, Events 202, 204, 206, Conditions 208, 210, 212, and Actions 214, 216, 218 are of two types; Contained components and Referencing components. As discussed above, Contained components are Policy Rule Components that are defined and described in the policy rule 110 itself, while Referencing components are components that identify Referenced components defined and described outside the Referencing Component.

These Referenced components are normally stored in a separate logical repository, but in some cases they can also be stored elsewhere in the same policy rule 110. This implies that a Contained component residing in a policy rule 110, in one embodiment, can be referenced by another Referencing component residing in the same policy rule 110. This referencing can occur in a scenario where a policy Event triggers some action in a policy rule 110 and can also be a sub-event in another Event in the same policy rule 110. The Contained component can also be referenced by another Referencing Event in another policy rule and hence, is both a Contained Component and a Referenced Component. It should be noted that a Contained Component cannot be a Referencing Component because they are mutually exclusive. Contained components are wholly contained within the containing component. They do not reference or refer to other components anywhere in the system 100. The details of these components are completely specified in the component itself.

A user having write access to a policy rule 110 can change the content of Contained components present in that policy rule 110. A Contained component can also be referenced by another Referencing component. For example, an Event can be a Contained component for a repository 112 (or even a policy rule 110) in which it resides, but is also a Referenced component for a policy rule 110 that refers to it using its Referencing component (which in this example is a policy Event in the policy rule that refers to this policy Event in the repository or policy rule).

The references of the Referencing components can be modified (they can be made to refer to another component of the same type), but the content of the Referenced components can only be changed, in one embodiment, by a user having write access to that particular Referenced component. However, when the Referenced component is modified, all the Referencing components that refer to this component are updated.

This approach gives various embodiments of the present invention two advantages. Using Referencing components in a policy rule 110 allows Events, Conditions, and Actions to be composed independently of each other and independent of the policy rules 110 that may use them. Referencing components also allow policy rule components to be referenced by multiple policy rules, thus increasing reusability and flexibility. At the same time, using Contained components, which are defined in the policy rule 110 itself allows the policy rule 110 to run more efficiently because additional accesses required to retrieve the Referenced component by the Referencing component are avoided. In addition this does not require edit permissions beyond the policy rule 110 itself. This method improves the performance of the system by reducing the time needed to look-up and access the Referenced component. Hence, the policy management system 100 of the various embodiments of the present invention allows Events, Conditions, and Actions to be linked either by reference (to improve flexibility) or by containment (to improve performance). This allows the system 100 to balance flexibility versus performance, enabling these two factors to be fine-tuned to suit the specific needs of different applications.

For example, in an implementation based on one embodiment of the present invention, a user might create several policies using Referencing components in a policy rule 110 that reference components in one or more repositories. While testing the policies, the user may continue to use the Referencing components for flexibility, giving the user the ability to make changes in one place that are automatically reflected in all affected policies. After the test phase, once the policies are ready to be deployed, a privileged user can convert these Referencing components into Contained components. When the user does this, a copy of the each of the components Referenced by the Referencing components is made and stored automatically in the corresponding policy. This reduces the time spent to look up the Referenced components and drastically improves the system performance. This gives the user flexibility (while testing) and performance (at deployment) when they are needed.

When a user converts a Referencing component to a Contained component, the references to the old components are not lost; the system 110 still stores the references to the old components. There are two reasons for keeping this seemingly useless reference. First, this reference to the old component allows the user to verify, at a later point of time, if there are any differences between the current Contained and the old Referenced components and resolve them. Second, this reference to the old component also allows the user to change the Contained component back to a Referencing component. Hence users are able to convert Referencing components into Contained components and vice-versa. These old references are referred to as soft links. The soft links are active (i.e. both the Referenced component and the Referencing component know about it) whenever a Referencing component has been converted to a Contained component. If a Referencing component is changed to reference to another Referenced component, the soft link is not active. However, the soft link is still stored in a stack to allow the user to undo the operation and point back to the old Referenced component.

A copy of policy elements can also be made. These copies can be either shallow copies or deep copies. A shallow copy includes a copy of the policy element without a copy of policy elements contained within the policy element. A deep copy includes a copy of the policy element and all other policy element contained within the policy element.

For example, assume a scenario where a user decides to change the Referenced components of a Policy to Contained components to realize better performance. After some performance tests, the user may find out that the author of the Action components in the policy rule has made some more changes that need to be synchronized with the current policy rule. Then, in one embodiment, the user is allowed to check for differences between the Contained component and the corresponding formerly Referenced component in the appropriate repository. The user can also be given the option of applying the changes in the Referenced component to the Contained component. This process is discussed in greater detail below.

In another embodiment, the user may make some changes to the Contained component and push these changes to the formerly Referenced component (if the user has sufficient privileges to modify the component repository). This way the changes get propagated to all the policy rules using that component. In yet another embodiment, the user may change the Contained component into a Referencing component and then ask the author of the Referenced component to make the required changes. When the author makes the required changes to the Referenced component, the Referencing component in the policy rule 110 gets updated automatically.

When a Contained component (that was previously a Referencing Component) is changed back to a Referencing Component and a change exists between the formerly Contained component and the newly defined Referenced component, one embodiment of the present invention provides the user two options. First, the contents of the newly defined Referenced component are adopted into the Contained component, thus losing the changes stored in the Contained component from when it was first a Referencing Component. Second, the changes in the Contained component are pushed into the newly defined Referenced component (provided the user has sufficient privileges). In the second option, if the user chooses to modify the Referenced component, this component sends a notification about the change to all other Referencing components. This allows the other Referencing components to get updated or forcing an update on all the Referencing components, depending on the preferences set by the user.

Other Contained components that had previously Referenced this changed Referenced component are also be notified (since the Referenced component stores references to all the components that reference them, including the ones that have active soft links) about this change, thus giving them an option to synchronize with the latest data. An implementation might also choose to turn this feature off and have the user check for any changes made components that were previously Referenced by the current component only when he/she wishes to do so. The above scenarios covering the change from a Contained component to a Referencing component and vice-versa are discussed in greater detail below. The actual Events, Conditions, Actions, and policy rules 110 can be stored in a repository or a set of repositories 108, 112, 114, 116 (abstracted away from the user so that they appear to be stored in a single repository) along with all their references, or assembled at edit time and stored as an atomic unit.

Policy Rules and the Policy Continuum

One embodiment of the present invention also provides details on how various policies generated in accordance with the Policy Continuum are to be stored, represented, and managed. (See for example a book by one of the co-inventors, “Policy-Based Network Management”, John C. Strassner, ISBN 1-55860-859-1, Morgan Kaufmann Publishers, Copyright 2004 at P. 23, FIGS. 1-8, which is hereby incorporated by reference in its entirety.) For multiple policies in the Policy Continuum, each policy can be a lower level elaboration of one or more higher level policies, and can also be a higher level abstraction of one or more lower level policies. (Note that Policy Level Continuum “levels” and “views” are used interchangeable throughout this discussion.) In such a case, these policies generally store the references for all the higher level policies (referred to as Parent policies or policy rules) and also store the references for or comprise of all the lower level policies (referred to as Child policies or policy rules).

A child policy rule supports and/or adds details to the parent policy rule(s) that it supports. The information about these policies, which are at different levels in the Policy Continuum, is stored in repositories similar to the Events, Conditions, and Actions discussed above. Along with the information (metadata) about the policies, the references to its parent and child policies are also stored in a policy. Following the same paradigm discussed above, parent policies can either reference (for flexibility) or embed (for performance) child policies. Also, as with Events, Conditions and Actions in a policy rule, a user is allowed to change Referenced child policies into Contained child policies and vice-versa.

In one embodiment, a graphical user interface enables each policy to be stored in its own container. Each container can be a portion of a repository or library, as explained above. Using this graphical user interface, exploring a policy shows the Parent or the Child policies in the hierarchy, depending on what the user wants to see. This allows the user to navigate the hierarchy in both top-down and the bottom-up directions, depending on the permissions given to him/her.

Examples of Policy Rule Creation

The following example discusses how a group of users can build a policy from scratch, assuming that the users have reached a consensus on the functionality of the policy according to one embodiment of the present invention. A network operator (who has knowledge about the network and the Events in the network, such as Alarms) logs into the system 100 with his or her credentials. This example's network operator belongs to the user group that has permissions to read policies and edit or create the Event components in the policy rule set. This network operator is a system Event specialist who does not compose policy rules 110, but rather exclusively builds Events used in policy rules 110 composed by other experts. In order to create this Event, the network operator uses the managed entities and the attributes that are available to him. Note that this is a realization of RBAC restrictions.

Other network operators who specialize in building Conditions and Actions do the same for their respective components. The operators log in and create Conditions and Actions and store them in the repository or the library. The network operators in this example have read-write access only to the components created by them in their respective libraries; all other dependencies are governed by appropriate RBAC policies. For example, it may be necessary for an editor of Conditions and Actions to see (but not be able to modify) Events.

The network administrator then logs on and creates policies using the resusable repository components (Events, Conditions, and Actions) composed by the network operators cited above. The network administrator may also be allowed to compose or edit Event, Condition, and Action components. This enables the network administrator to hand-tailor reusable components to his or her application-specific needs. The network administrator can also edit default Events, Conditions, and Actions that are provided as a starting point for a new policy rule 110. This allows the administrator to use existing policy rules as a basis for new policy rules 110.

Another embodiment of the present invention implements the concept of a template. A template is a pre-defined policy rule 110 or policy rule Component (Event, Condition, or Action) with default parameters that provide a foundation to help users build policy rules 110 and policy rule Components quickly. Template policy rules can also be provided for various general contexts (e.g., edge router vs. core router policy rules). A template policy rule or a template policy rule Component is similar to a policy rule 110 or a policy rule Component, respectively but are built to achieve certain functionality that can be modified by the user. The purpose of a template policy rule, in one embodiment, is to speed development and to ensure structural consistency of policy rules 110 and policy rule Components by providing a standardized structure that can then be customized as needed. After creating a policy rule 110 or a policy rule Component, a user can mark that Component as a template, effectively telling other users of the system that this template can be modified and reused to accomplish a function or set of functions. Components that are marked as templates can be grouped together physically (e.g., in the same storage partition) and/or logically (e.g., in the same virtual container) to make it easier to find them.

For example, in one embodiment, a user can search for all available templates for a core-router policy rule template and make some changes to the default parameters to build a core-router policy rule quickly. The user can also make changes to the Events, Conditions, and Actions provided in this template. This standardizes how policies are built to control routers whose role is “core”.

In another implementation, a user can use a Voice Service Quality Template Events to create policy Events that can be used to monitor the Voice Service Quality Key Quality Indicator (“KQI”) in a network. The user can change the default parameters in this template event to create new Policy Events that can be used to build new policy rules (e.g., to add new Key Performance Indicators (KPIs) and/or KQIs to the Voice Service Quality definition for the policy rules to monitor and take action on). An administrator (or a user who has write access to the repository) can also add the Event, Condition, and Action components that he or she has created to the repository to be reused by other network administrators to create new policy rule sets. For example, in one embodiment, an administrator, after creating a policy rule 110 to manage an edge router using a template, can copy the policy Event used in the policy rule to the policy Event repository. This Event can then be reused by other policy rules 110, for example to detect any events that may affect the Quality of Service in the network. After creating the policy rules 110, the user can then navigate the hierarchy of the policy rule set and the policies in the Policy Continuum, both top-down and bottom-up, as discussed above.

A More Detailed Discussion on Creating Policy Rules

The following is a more detailed discussion on building policy rules using the policy management system 110 of the various embodiments of the present invention. Various non-limiting examples are used throughout this discussion accompanied by operational flow diagrams. For each operational flow diagram discussed below it is assumed that a user has logged into the policy management system 100. Depending on the user's permissions, the user can work on a particular part of the policy management system 100. User permissions, in one embodiment, are checked before the user is allowed to perform any activity in the system 100.

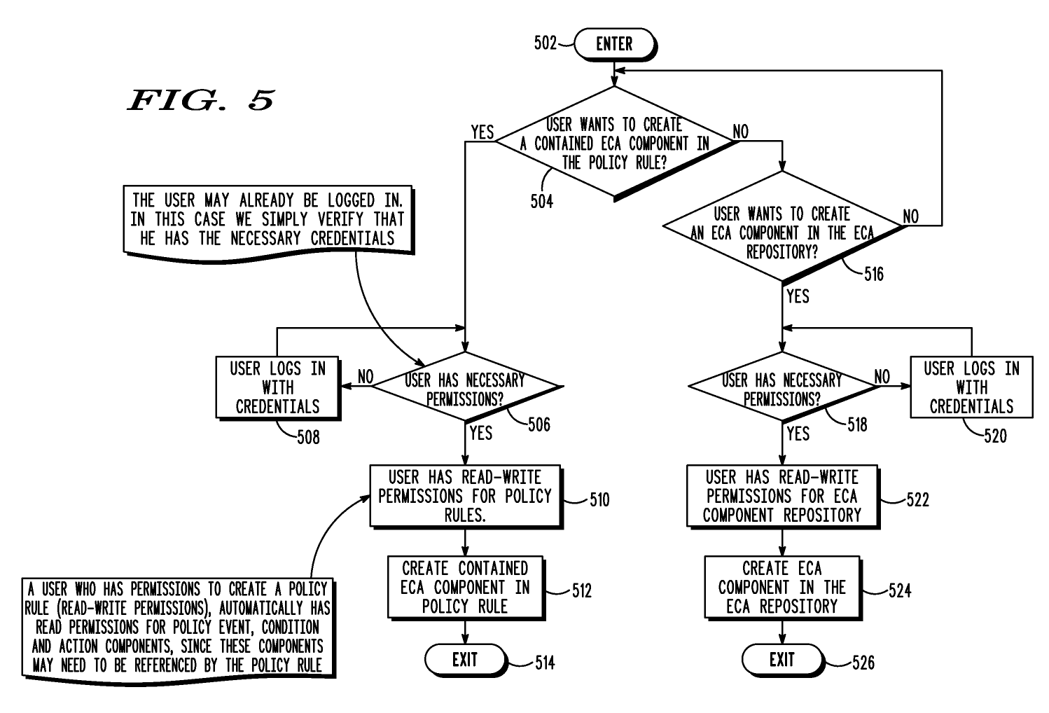

FIG. 5 is an operational flow diagram showing one process for creating policy rule components (e.g., Events, Conditions, Rules, and the like). It should be noted that a policy rule component can reside anywhere, in the repository or a policy rule. Policy rule components are ECA components. An ECA component implies an Event, Condition, or Action. Also, ECA components can reside in a Policy Rule or a Policy Rule Template or even in a repository.

FIG. 5 further shows how a user can create these components as Contained policy rule component or in one or more respective repositories (as a component that may be referenced by other components). Note that a Contained policy rule component (in a policy rule 110) can also be referenced by another Referencing policy rule component and hence can also behave like a Referenced policy rule component. When a user logs into the system 100 he/she has two options that decide the logical location of the new policy rule component. Depending on whether the user wants to create the policy rule component in the policy rule 110 or in the repository, the system 100 verifies that the user has the necessary permissions to create the new policy rule component. The user is then allowed to create a policy rule component using any method desired.

The operational flow diagram of FIG. 5 begins at step 502 and flows directly to step 504. The policy manager 106, at step 504, determines if the user wants to create a Contained policy rule component in the policy rule 110. If the result of this determination is positive, the policy manager 106, at step 506, determines if the user has the necessary permissions. If the user has already logged in, the policy manager 106 verifies the credentials of the user. If the result of this determination is negative, the user at step 508 is prompted to log in with the necessary credentials and the control returns to step 506. If the result of this determination is positive, the policy manager 106, at step 510 determines the permissions associated with the user. In the example of FIG. 5, the user is determined to have read-write permissions for policy rules 110. In one embodiment, a user who has read-write permissions to create and edit a policy rule 110 automatically has read permissions for policy rule 110 components. This is because these components may be needed to be turned into Referencing components at a later date by the policy rule 110. The user, at step 512, then creates the Contained policy rule component (Events 202, Conditions 208, or Actions 214) in the policy rule 110. This can be performed in a number of ways, including, but not limited to, interacting with a wizard, selecting from a menu, right-clicking on a context menu, command line entry, and the like. The control flow exits at step 514.

Returning to step 504, if the result of this determination is negative, the policy manager 106, at step 516, determines if the user wants to create a policy rule component in a repository such as the Event repository 112, Condition repository 114, and/or the Action repository 116. If the result of this determination is negative, the control flow returns to step 504. If the result of this determination is positive, the policy manager 106, at step 518, determines if the user has the necessary permissions. If the user has already logged in, the policy manager 106 verifies the credentials of the user. If the result of this determination is negative, the user at step 520 is prompted to log in with the necessary credentials and the control returns to step 518. If the result of this determination is positive, the policy manager 106, at step 522 determines the permissions associated with the user. In the example of FIG. 5, the user is determined to have read-write permissions for policy rules 110. The user, at step 524, then creates the policy rule component in a repository. This can be performed by, for example, interacting with a wizard, selecting from a menu, right-clicking on a context menu, command line entry, and the like, or more directly in another embodiment by, for example, the user setting the required fields directly in a form. The control flow exits at step 526.

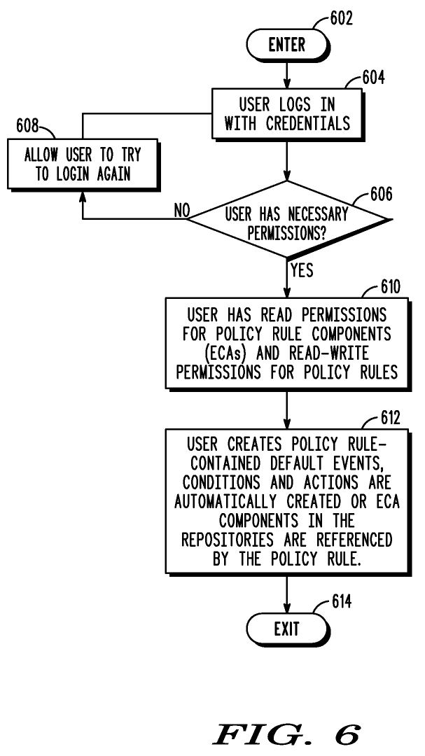

FIG. 6 is an operational flow diagram illustrating one example of creating a policy rule. The operational flow diagram of FIG. 6 begins at step 602 and flows directly to step 604. The user, at step 604, logs in with his/her credentials. The policy manager 106, at step 606, determines if the user has the necessary permissions. If the result of this determination is negative, the policy manager 106, at step 608, prompts the user to log in with the necessary credentials. The control flow returns to step 604. If the result of this determination is positive, the policy manager 106, at step 610, determines the permissions of the user. In the example of FIG. 6, the policy manager 106 determines that the user has read permissions for policy rule components and read-write permission for policy rules.

The issue of permissions for policy rules 110 is complex. This is because a policy rule 110 is built from a set of policy rule components, and different permissions may apply to the policy rule 110 vs. its policy rule components. This is because a policy rule 110 is a container. Therefore, in this role, a policy rule 110 simply aggregates policy rule components. Hence, it is the actual policy rule components that control the functionality of the policy rule 110. However, this may not always be the case. For example, a user may need to construct a customized policy rule 110 including its components, and hence requires the same permission for all components.

In another embodiment, the concept of role-based access control may be embedded in the policy management system 100. Hence different policy rules 110 and policy rule components may have different permissions. This effectively limits the construction of a policy rule or composite policy rule events, conditions, and actions.

In one embodiment, a user who has permissions to create a policy rule 110 (read-write permissions) automatically has read-write permissions for the default Contained components that come with a newly created policy rule 110, but only read permissions for other policy rule components that reside outside of the policy rule. Read permissions are granted for these policy rule components because these components may need to be referenced by the policy rule 110. Returning back to FIG. 6, the user, at step 612, creates a policy rule 110. Whenever a new policy rule 110 is created, a default set of events, conditions, and actions are also provided as Contained components. The content of these Contained components can be modified by a user who has write permission on a policy rule 110 that includes these Contained components. However, these Contained components, in one embodiment, can only be changed into Referencing components if the user has that particular privilege. Furthermore, adding new components or deleting the default Contained component is an extra privilege that must be explicitly granted by the system administrator.

In another embodiment, the user has an option to specify which Event(s) 118, Conditions (s) 120, and/or Action(s) 122 are to be included in the new policy rule 110 from external Repositories during the time that the policy rule is being created. As a result, Referencing Event(s), Condition(s), and Action(s) are automatically created for each policy rule component to be referenced in the policy rule 110. The user also has an option of defining and optionally specifying the Contained Event(s), Condition(s), and/or Action(s) that are to be present in the policy rule 110. If no Event(s), Condition(s), and/or Action(s) are specified while creating the policy rule 110, the system 100 creates default Event, Condition and Action stubs for the policy rule 100 and marks it as disabled (since it cannot be successfully parsed and executed yet). It should be noted that a rule can have one or more active events, conditions, and actions. For example, there can be more than one event or a combination of events that trigger the evaluation of a policy condition, more than one condition, or a combination of conditions that are evaluated, and more than one action or a combination of actions that are executed. The control flow exits at step 614.

Information Processing System

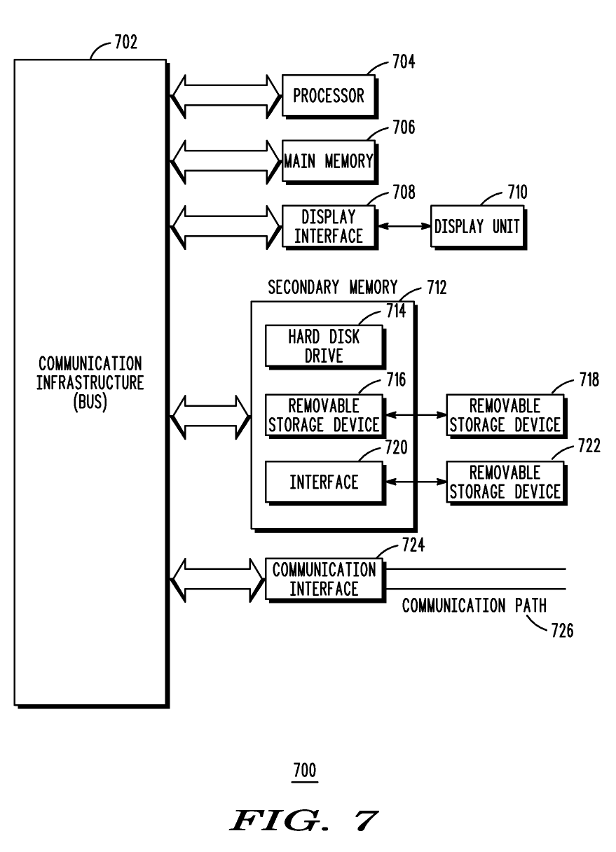

FIG. 7 is a high level block diagram illustrating a detailed view of a computing system 700 useful for implementing the policy manager 106 according to embodiments of the present invention. The computing system 700 is based upon a suitably configured processing system adapted to implement an exemplary embodiment of the present invention. For example, a personal computer, workstation, or the like, may be used.

In one embodiment of the present invention, the computing system 700 includes one or more processors, such as processor 704. The processor 704 is connected to a communication infrastructure 702 (e.g., a communications bus, crossover bar, or network). Various software embodiments are described in terms of this exemplary computer system. After reading this description, it becomes apparent to a person of ordinary skill in the relevant art(s) how to implement the invention using other computer systems and/or computer architectures.

The computing system 700 can include a display interface 708 that forwards graphics, text, and other data from the communication infrastructure 702 (or from a frame buffer) for display on the display unit 710. The computing system 700 also includes a main memory 706, preferably random access memory (RAM), and may also include a secondary memory 712 as well as various caches and auxiliary memory as are normally found in computer systems. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art.

Removable storage unit 718, represents a floppy disk, a compact disc, magnetic tape, optical disk, etc. which is read by and written to by removable storage drive 716. As are appreciated, the removable storage unit 718 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer-readable information.

In alternative embodiments, the secondary memory 712 may include other similar means for allowing computer programs or other instructions to be loaded into the policy manager 106. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computing system 700.

The computing system 700, in this example, includes a communications interface 724 that acts as an input and output and allows software and data to be transferred between the policy manager 106 and external devices or access points via a communications path 726. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. The signals are provided to communications interface 724 via a communications path (i.e., channel) 726. The channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. The computer program products are means for providing software to the computer system. The computer readable medium allows the computer system to read data, instructions, messages or message packets, and other computer readable information from the computer readable medium.

Computer programs (also called computer control logic) are stored in main memory 706 and/or secondary memory 712. Computer programs may also be received via communications interface 724. Such computer programs, when executed, enable the computer system to perform the features of the various embodiments of the present invention as discussed herein. In particular, the computer programs, when executed, enable the processor 704 to perform the features of the computer system.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for managing policy elements in an information processing system, the method comprising:
retrieving at least one policy element from a plurality of policy elements stored in at least one policy repository, wherein the plurality of policy elements include at least one of
a plurality of reusable policy rules,
a plurality of reusable policy rule components,
a plurality of reusable policy rule templates, and
a plurality of and policy rule component templates;
creating a new reusable policy element from at least one of
the policy element that has been retrieved, and
a default policy element;
storing the new reusable policy element in the at least one policy repository; and
querying a reusable policy element using metadata associated with the reusable policy element.

2. The method of claim 1, wherein the storing further comprises at least one of:
determining a repository in the plurality of repositories comprising storage space for storing the new reusable policy element based on the metadata associated with the new reusable policy element.

3. The method of claim 1, wherein the plurality of reusable policy rule components include at least:
Metadata;
Events;
Conditions; and
Actions.

4. The method of claim 1, wherein each policy rule in the plurality of policy rules and each policy rule template in the plurality of policy rule templates includes at least one pointer to a policy rule component and a policy rule component template it contains, wherein the pointer is used by at least one of a human user and a machine user to identify one of the policy rule components and policy rule component templates used in one of the policy rule and policy rule template, respectively, and wherein
each policy rule component in the plurality of policy rule components and each policy rule component template in the plurality of policy rule component templates includes at least one pointer to a policy rule and policy rule template containing the policy rule component and the policy rule component template, respectively, wherein the pointer is used by at least one of a human user and a machine user to identify one of the policy rule and policy rule template that use the policy rule component and the policy rule component template, respectively.

5. The method of claim 1, wherein the at least one repository is one of a physical storage entity and a logical partition of a physical storage entity.

6. The method of claim 1, wherein at least one policy element in the plurality of policy elements are stored in a different repository than the other policy elements.

7. The method of claim 6, wherein the different repository is at least one of a different physical entity and a different logical partition of an original physical entity for enabling both physical.

8. The method of claim 1, wherein each of the policy elements in the plurality of policy elements support management operations, where the management operations include at least one of:
changing a name of an existing policy element, thereby causing the existing policy element to be known by a new name;
creating a copy of a policy element;
creating at least one different version of a policy element, wherein the creating different version at least includes creating different named policy elements that are uniquely identifiable for supporting different functionality;
changing a storage location of a policy element; and
updating a policy element to identify a location of a reusable policy rule component whose location has been changed.

9. The method of claim 8, wherein the copy of the policy element includes at least one of:
a shallow copy of the policy element, wherein a shallow copy includes a copy of the policy element without a copy of policy element contained within the policy element; and
a deep copy of the policy element, wherein a deep copy includes a copy of the policy element and all other policy element contained within the policy element.

10. The method of claim 8, wherein creating at least one different version of a policy element further comprises:
determining a set of permissions associated with the policy element; and
associating the set of permissions determined to be associated with the policy element to the at least one different version that has been created.

11. The method of claim 1, wherein the creating at least one new reusable policy element, further comprises:
determining a set of permissions associated with at least one of a human user and a machine user; and
authorizing one of the human user and the machine user to perform a set of management operations on the new reusable policy element based on the set of permissions determined to be associated with the at least one human user and the machine user.

12. The method of claim 11, wherein set of management operations include at least one of:
creating;
modifying;
deleting;
copying;
moving; and
renaming at least one of policy elements.

13. The method of claim 11, wherein the creating the new reusable policy element, further comprises:
determining a set of permissions associated with the new reusable policy element that has been created;
identifying a set of policy rule components that reference the new reusable policy element and a set of policy rule components referenced by the new reusable policy element, wherein a policy rule component includes at least one of Events, Conditions, Actions, and Metadata, and wherein the set of permissions also impact the set of policy rule components that reference the new reusable policy element and a set of policy rule components referenced by the new reusable policy element.
authorizing one of the human user and the machine user to perform a set management operations on the new reusable policy element based on both the set of permissions determined to be associated at least one of the human user and the machine user and the set of permissions determined to be associated with new reusable policy element.

14. The method of claim 13, further comprising:
copying the new reusable policy element, wherein the copying creates one of a shallow copy of the new reusable policy element and a deep copy of the new reusable policy element; and
associating the set of permissions determined to be associated with the new reusable policy element with the one of a shallow copy the new reusable policy element and a deep copy of the new reusable policy element.

15. The method of claim 1, wherein the at least one repository further comprises an organizational structure that enforces at least one role-based access control on each entry in the repository as well as the repository itself.

16. The method of claim 15, wherein the role-based access control includes:
ensuring that a user has appropriate permissions to operate on the policy element as well as contents of the policy element; and
ensuring that the policy element has appropriate permissions to allow operations requested by the user to be performed on the policy element.

17. A method for managing policy elements in an information processing system, the method comprising:
retrieving at least one policy element from a plurality of policy elements stored in at least one policy repository, wherein the plurality of policy elements include at least one of
a plurality of reusable policy rules,
a plurality of reusable policy rule components,
a plurality of reusable policy rule templates, and
a plurality of and policy rule component templates;
creating a new reusable policy element from at least one of
the policy element that has been retrieved, and
a default policy element;
storing the new reusable policy element in the at least one policy repository;
querying a reusable policy element using metadata associated with the reusable policy element;
determining a set of permissions associated with at least one of a human user and a machine user; and
authorizing one of the human user and the machine user to perform a set of management operations on the new reusable policy element based on the set of permissions determined to be associated with the at least one human user and the machine user.

18. The method of claim 17, wherein each of the policy elements in the plurality of policy elements support management operations, where the management operations include at least one of:
changing a name of an existing policy element, thereby causing the existing policy element to be known by a new name;
creating a copy of a policy element;
creating at least one different version of a policy element, wherein the creating different version at least includes creating different named policy elements that are uniquely identifiable for supporting different functionality;
changing a storage location of a policy element; and
updating a policy element to identify a location of a reusable policy rule component whose location has been changed.

19. An information processing system for managing policy elements in an information processing system, the information processing system comprising:
a memory;
a processor communicatively coupled to the memory; and
a policy manager communicatively coupled to the memory and the processor, wherein the policy manager is adapted to:
retrieve at least one policy element from a plurality of policy elements stored in at least one policy repository, wherein the plurality of policy elements include at least one of
a plurality of reusable policy rules,
a plurality of reusable policy rule components,
a plurality of reusable policy rule templates, and
a plurality of and policy rule component templates;
creating a new reusable policy element from at least one of the policy element that has been retrieved;
a default policy element;
store the new reusable policy element in the at least one policy repository; and
query a reusable policy element using metadata associated with the reusable policy element.

20. The information processing system of claim 19, wherein each of the policy elements in the plurality of policy elements support management operations, where the management operations include at least one of:
changing a name of an existing policy element, thereby causing the existing policy element to be known by a new name;
creating a copy of a policy element;
creating at least one different version of a policy element, wherein the creating different version at least includes creating different named policy elements that are uniquely identifiable for supporting different functionality;
changing a storage location of a policy element; and
updating a policy element to identify a location of a reusable policy rule component whose location has been changed.
